(19) United States
(12) Patent Application Publication
(10) Pub. No.: US 2014/0028097 A1
(43) Pub. Date: Jan. 30, 2014

(54) ELECTRICAL OUTLET ADAPTER WITH AUTOMATIC POWER-ON AND POWER-OFF OF PERIPHERAL OUTLETS

(71) Applicant: Dennis Harold Augur, Fulton, MO (US)

(72) Inventor: Dennis Harold Augur, Fulton, MO (US)

(21) Appl. No.: 13/556,940

(22) Filed: Jul. 24, 2012

(51) Int. Cl. H02J 3/00

(52) U.S. Cl. 307/39

(57) ABSTRACT

A device for reducing energy waste includes an electrical adapter having outlets, including at least one primary outlet, disposed along a surface thereof, and a sensor for determining when power consumed by a device plugged into the primary outlet drops below a predetermined threshold. The sensor is a fuse, a circuit breaker, or a length of wire. When power consumed by a device plugged into the primary outlet drops below the predetermined threshold, the power provided to at least one of the other outlets is interrupted.

### RELATED APPLICATIONS

Not Applicable.

### BACKGROUND OF THE INVENTION

1. Field of the Invention

The present invention relates generally to outlets or adapters for plugging in electric or electronic devices, and more specifically to a multi-outlet adapter for powering down peripherals plugged thereinto when a primary device is powered down.

2. Description of the Prior Art

As energy costs rise and non-renewable energy sources dwindle, conservation is increasingly at the forefront of the public consciousness. In both commercial and residential settings, individuals seek ways to reduce energy costs and to reduce their footprint on the environment. Many cost-cutting or conservation practices are incremental and serve as components of a larger, eco-friendly lifestyle.

Many electronic devices serve as primary devices to which other electronic devices are attached as peripherals. For example, a computer system may have a printer, scanner, monitor, external drive, or other device attached thereto. Likewise, an entertainment system may include a receiver, CD and/or DVD player, a television, separately-powered speakers, or other components. A common feature of many such peripheral devices is that they serve no purpose when the primary device is not in use. Nevertheless, many people leave the peripheral devices turned on when the primary device is not in use. This is sometimes done inadvertently, and otherwise done to avoid the inconvenience of turning off all of the peripheral devices. Each peripheral device left on when the primary device is not in use consumes energy unnecessarily. This leads to an increased cost to the consumer and furthermore wastes energy.

An attempt has been made to address this problem in the form of a power strip that automatically powers-down peripheral devices when a primary device is powered-down. Such a device suffers from disadvantages, however. For example, a power strip type device is freestanding, usually on a floor, and therefore takes up space and clutters the area behind or around electronic equipment. Furthermore, a power strip has cord that connects to a plug so that the power strip can be plugged into a wall outlet. This cord is another source of clutter and can become entangled with multiple cords already behind or around electronic equipment.

What is needed, therefore, is a device adapted to replace a typical electrical outlet and adapted to provide for the automatic shut down of peripheral devices when a primary device is powered down. Further, it is desirable that such a device automatically provide power to peripherals once a primary device is turned on.

It is further desirable to provide a device adapted to provide automatic shut down of peripheral devices then a primary device enters into a sleep or standby mode. It is also desirable to provide such a device wherein the internal circuitry of the device consumes as little power as possible, and generates as little heat as possible, while still providing the functionality above.

### SUMMARY OF THE INVENTION

The present invention provides a device for reducing energy waste includes an electrical adapter having outlets, including at least one primary outlet, disposed along a surface thereof, and a sensor for determining when power consumed by a device plugged into the primary outlet drops below a predetermined threshold. The sensor detects a change in current flowing through a component such as a fuse, a circuit breaker, or a length of wire. When power consumed by a device plugged into the primary outlet drops below the predetermined threshold, the power provided to at least one of the other outlets is interrupted.

In another aspect of the present invention, the present device is sized and shaped to mate with a pre-existing electrical outlet.

In another aspect of the present invention, the predetermined threshold is the threshold at which the device plugged into the primary outlet enters a mode selected from the group consisting of a sleep mode, a standby mode, and a power-saving mode.

### BRIEF DESCRIPTION OF THE DRAWINGS

FIG. 1 is a front perspective view of one embodiment of a device constructed in accordance with the teachings of the present invention.

FIG. 2 is a rear view of one embodiment of a device constructed in accordance with the teachings of the present invention.

FIG. 3 is a side perspective view of one embodiment of a device constructed in accordance with the teachings of the present invention.

FIG. 4 is a circuit diagram showing a circuit suitable for use with one embodiment of the present invention.

### DETAILED DESCRIPTION OF THE PREFERRED EMBODIMENTS

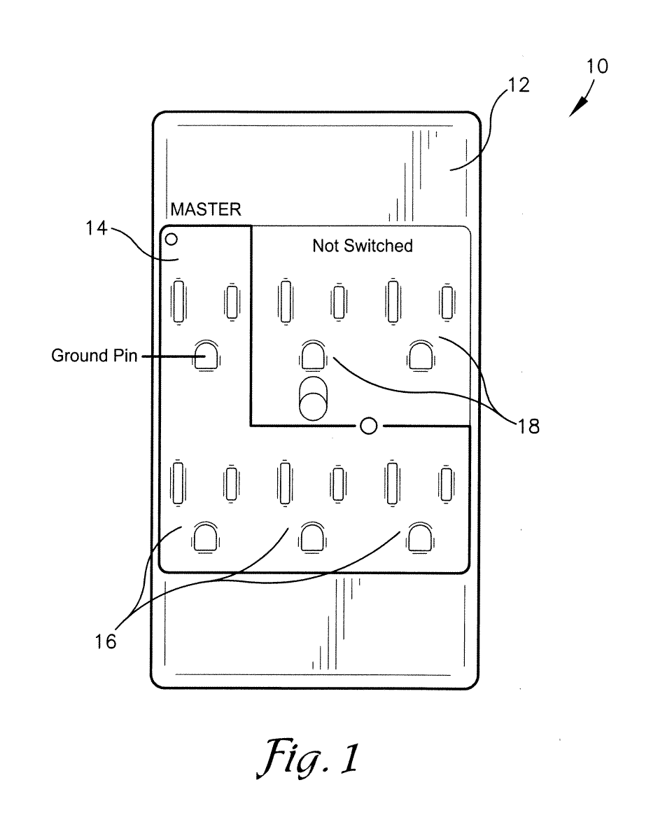

Turning now to the drawings, wherein like numerals indicate like parts, the numeral 10 indicates generally a six-outlet embodiment of the device of the present invention. This embodiment of device 10, shown in FIG. 1, also includes a housing 12, a primary outlet 14, three peripheral outlets 16, and two independent outlets 18. It is contemplated that the number and arrangement of such outlets may vary without departing from the spirit or scope of the present invention.

Housing 12 of device 10 may be constructed of any suitable material, and may be provided in any suitable size, shape, or configuration. An exemplary material suitable for use in the construction of housing 12 is polypropylene. A second exemplary material is polyvinyl chloride (PVC). Materials suitable for use in the construction of housings for electrical outlets, adapters, and the like are well known in the art.

Referring still to FIG. 1, a primary outlet 14 is provided for accepting a typical two- or three-prong plug from an electronic device. Primary outlet 14 includes, associated therewith, a sensor (described more fully below) that is able to sense the amount of current being drawn through primary outlet 14 to power a device plugged into primary outlet 14. Peripheral outlets 16 are also of the type typically utilized to accept a two- or three-prong plug from an electronic device. Peripheral outlets 16 are preferably in electronic communication with primary outlet 14 such that peripheral outlets 16 are controlled by primary outlet 14.

For example, when an electronic or other device is plugged into primary outlet 14, a sensor included in device 10 monitors the electrical usage of the electronic or other device by monitoring the current drawn through primary outlet 14. As such, device 10 is able to determine whether the device plugged into primary outlet 14 is on or off. When the device plugged into primary outlet 14 is turned on, device 10 also provides power to peripheral outlets 16 so that peripheral devices plugged into peripheral outlets 16 receive power. The devices plugged into peripheral outlets 16 may include, for example, a printer, scanner, and monitor associated with a computer plugged into primary outlet 14. When a device plugged into primary outlet 14 is turned off, a sensor associated with device 10 is able to determine that the device plugged into primary outlet 14 is either drawing no power or substantially less power. Device 10 will then stop providing power to peripheral outlets 16, causing the various devices plugged into peripheral outlets 16 to be turned off or powered down. As a result, energy and cost is saved because the peripheral devices are not consuming power when they clearly are not needed and will not be in use.

In addition to the functionality described above, it is preferred that a sensor associated with device 10 can also determine when a device that was previously off and plugged into primary outlet 14 has been turned on. This is again accomplished by monitoring the current flowing through primary outlet 14. When device 10 recognizes that the device plugged into primary outlet 14 has been turned on again, power is preferably provided to peripheral outlets 16. Thus, once the primary device is powered on, the peripheral devices also receive power without the need for the user to manually turn them on.

A sensor as described above may be set for a predetermined current threshold such that when the current drops below the threshold, the device plugged into primary outlet 14 is considered to be “off,” and power to peripheral outlets 16 is interrupted. Depending on the threshold settings, it is not necessary that a device plugged into primary outlet 14 actually be off before power to peripheral outlets 16 is interrupted. Rather, the device plugged into primary outlet 14 may have simply moved into a standby mode, and the sensor associated with the present device may be set with a threshold such that moving into standby mode triggers the present device to cut power to peripheral outlets 16. It should be noted that such sensors for determining the amount of current passing through a circuit are known in the art.

The thresholds at which a sensor is set may be determined at the time of manufacture of the present device (i.e. set at the factory), or may be adjustable by a user of the present device. In some embodiments of the present invention, an LCD or other display may be provided so that the end user of the present device can see the precise threshold settings (and any other desirable information) displayed thereon.

Also included with the embodiment of device 10 shown in FIG. 1 are two independent outlets 18. Independent outlets 18 are preferably adapted to receive a typical two- or three-prong plug, and function as normal electrical outlets. That is, power is always provided to independent outlets 18. Thus, the on or off status of a device plugged into primary outlet 14 will not affect the delivery of power to independent outlets 18. Independent outlets 18 may therefore be used to power any devices that should be retained in an always on state, or that should only be powered down when a user of device 10 manually turns them off or unplugs them.

The rear of device 10 is preferably adapted to take the place of, or be inserted into, a standard two-outlet electrical wall outlet. As such, device 10 does not take up space on the floor of a room or other area in which it is being used, and does not include an electrical cord that must be plugged into an outlet, further creating clutter.

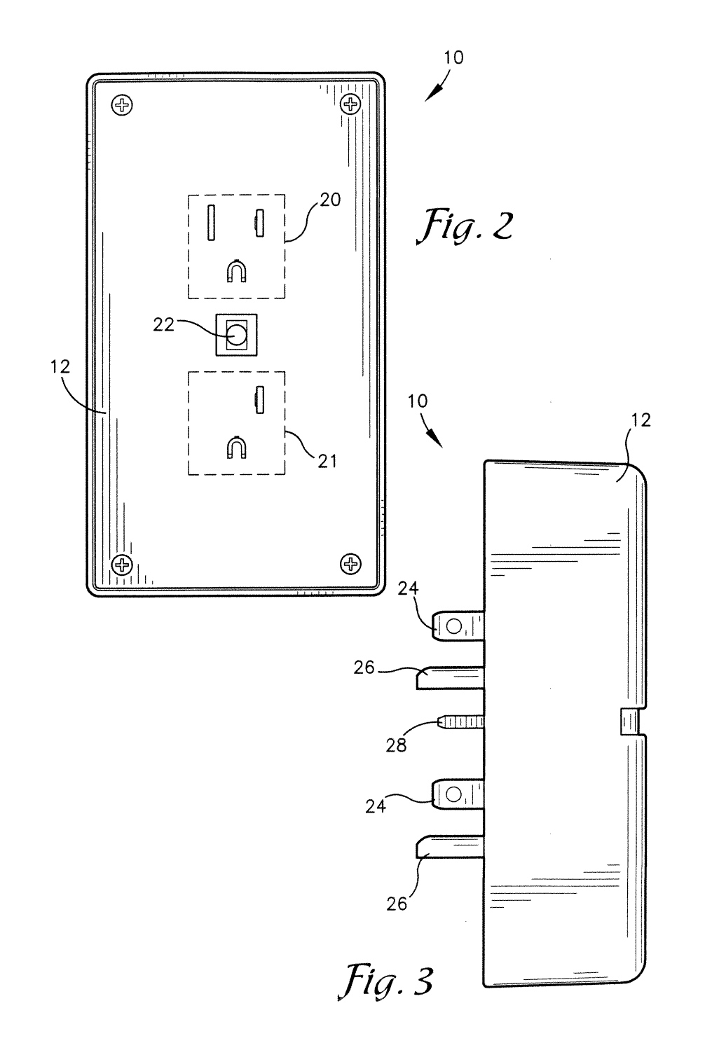

FIG. 2 provides a rear view of one embodiment of a device 10 constructed in accordance with the teachings of the present invention. In the embodiment shown, a housing 12 is provided, as with the embodiment of device 10 shown in FIG. 1 (in fact, the view shown in FIG. 2 is one possible configuration for the rear of the embodiment of device 10 shown in FIG. 1). Housing 12 is shown in FIG. 2 as having two parts, including a rear panel fastened to a front of housing 12 by four screws. It is contemplated, however, that housing 12 may also be constructed from a single, unitary piece of material molded into the proper shape or configuration.

Device 10 in FIG. 2 includes a three-pronged plug 20 and a modified two-pronged plug 21. It is preferred that three-pronged plug 20 and modified two-pronged plug 21 are sized, shaped, and spaced to mate with a typical two-outlet electrical wall outlet. Three-pronged plug 20 includes two upper prongs as well as a lower prong designed to serve as a ground (these prongs are known as the neutral, hot, and ground, and are used in polarized outlets). Modified two-pronged plug 21 includes one upper prong (the neutral prong) and the ground prong found in a typical three-pronged plug. There is no hot prong associated with modified two-pronged plug 21 so that current provided to peripheral outlets 16 is governed by primary outlet 14, which receives current via three-pronged plug 20. The principles of the present invention may, however, be implemented with a device adapted to mate with any suitable outlet—for example only three-pronged plug 20 may be present, with modified two-pronged plug 21 being eliminated). In the embodiment of device 10 shown in FIG. 2, a user of device 10 can simply plug device 10 directly into an existing wall outlet. No disassembly of the wall outlet is required. This embodiment provides for ease of use and reduces the risk of electrical shock to a user attempting to install device 10. Also shown in FIG. 2 is a opening 22 for a screw for fastening device 10 to a bracket within a wall outlet, thereby ensuring that, if desired, device 10 may be not only plugged into an existing wall outlet but securely affixed thereto.

FIG. 3 provides a side view of an exemplary embodiment of device 10 of the present invention. The various prongs associated with the two three-pronged plugs 20 on the rear of device 10 are shown extending away from housing 12. Prongs 24 are the hot prongs associated with a plug adapted for use with a polarized outlet. Prongs 26 are the ground prongs. It is contemplated that two ground prongs 26 are not necessary in all implementations of the present device, and depending on the wiring of the device may not be desired in all implementations. In some implementations of the present device, in order to control the switched outlets, the high-side 110V pin corresponding to the three peripheral outlets 16 is not connected to the main power from the wall outlet with which device 10 is associated. This pin, if present, is non-operational in this implementation of the present device. Rather, the pin is internally switched via internal circuits. The pin can be eliminated without any change in function of this implementation of device 10. Variations on the number of prongs associated with the present device may be made without departing from the spirit or scope of the present invention. The neutral prongs are adjacent the hot prongs, but are not visible in FIG. 3. A Screw 28 is also shown in the figure. Screw 28 extends through opening 22 of device 10 and is used to secure device 10 to an electrical outlet. Although a screw is described above and shown in the drawings, any suitable fastener may be utilized.

It is further contemplated that the sensor associated with device 10 may be any component that enables the device to detect the amount of power passing through device 10 to a device plugged into primary outlet 14. The sensor may, for example, be a fuse, a circuit breaker, or a length of wire along which device 10 detects a drop in current. Thus, while the word “sensor” is employed herein, the word is used in a descriptive sense. In its most basic form, the sensor may simply be a length of wire, device 10 being adapted to determine a current flow along the length of wire, and thereby being adapted to determine a change in the current. Use of a length of wire as the “sensor” of the present system provides for ease of manufacture and eliminates the need for most costly sensor components. For safety reasons, a fuse or circuit breaker may be used as well. Any electronic or electrical component suitable for use in determining a change in current flowing to a device plugged into master outlet 14 may be used in conjunction with device 10.

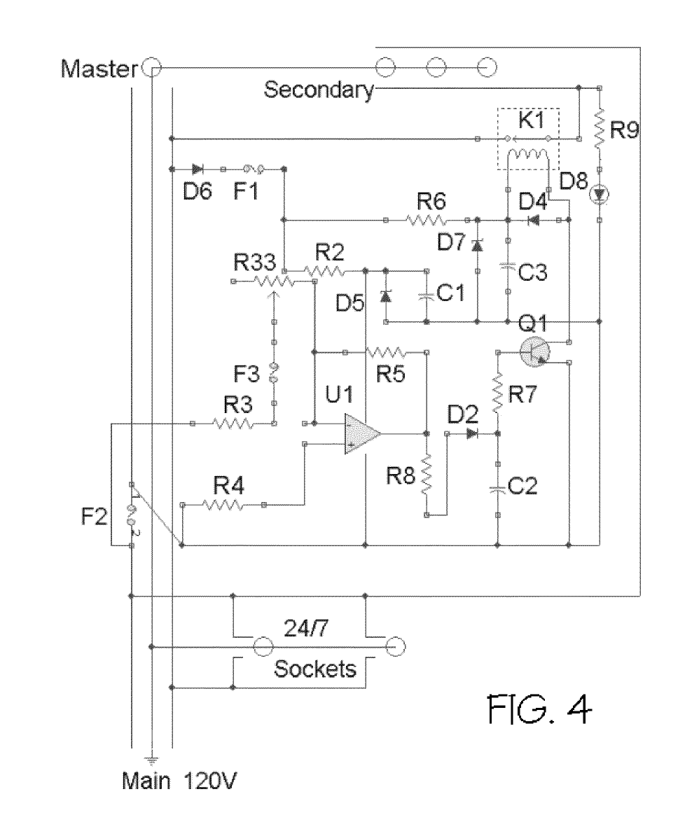

FIG. 4 provides an exemplary circuit diagram of a circuit suitable for use with one embodiment of the present invention. The circuit can be divided, conceptually, into subsections as follows: 1) two DC power supplies D5 and D7 (Zener diodes and associated circuitry); 2) one comparator U1; 3) one transistor DC power switch Q1; and 4) one AC power relay K1.

As shown in FIG. 4, two integrated Zener controlled power supplies D5 and D7 are provided. D5 is preferably a fifteen volt DC power supply, while D7 is preferably a forty-seven volt DC power supply. Each Zener diode has specific resistors and capacitors associated therewith to develop and control the specific output voltages. It is contemplated that the functionality of the Zener controlled power supplies will be readily ascertainable by one of skill in the art upon reading this disclosure.

Still referring to FIG. 4, S1 F2 can be a sacrificial fuse, a circuit breaker, or a short length of wire, as described above. The circuitry shown in FIG. 4 has the ability to detect pico-amp changes in current flowing through numerous electrical or electronic components. According to Ohm's Law, any resistance, capacitance, or inductance will consume or dissipate power, even if only in miniscule amounts. Thus, as electricity passes through carriers (such as the fuse, circuit breaker, or length of wire, above), power is lost due to one or more of the reasons stated above.

Voltage comparator U1 compares the input voltages on pins 2 and 3 and outputs a proportional voltage to pin 1. The output voltages from S1 are sent to U1 via R3, R4, and adjustable R33. R33 sets the voltage balance across pin 2 and 3 of U1. Using S1 inputs, a proportional output voltage from U1 pin 1 is sent to the base of transistor DC power switch Q1. Q1 conducts when the positive voltage on the base exceeds break over voltage. Q1 provides the ground to the K1 coil, causing K1 to close the power path to secondary or peripheral AC outlets. When positive voltage from U1 on the base of Q1 drops below that is necessary for Q1 to conduct, K1 drops out and the secondary or peripheral outlets no longer receive power.

Stating the functionality in another manner, as the device connected to the master outlet of the present invention consumes power above a threshold set by R33, the voltages on pin 2 and pin 3 of U1 will be out of balance to the positive side. U1 will output a positive voltage to the base of Q1. This positive voltage on the base of Q1 will cause Q1 to conduct and supply a ground to the coil of K1. K1 closes and delivers power to the secondary or peripheral outlets. Alternatively, as the device connected to the master outlet of the present invention consumes power below the threshold set by R33, the voltages to pin 2 and pin 3 of U1 will go to zero or a negative or reverse balance. U1 will output a zero or a negative voltage to the base of Q1, causing Q1 to stop conducting, which will in turn interrupt the ground supplied to the coil of K1. K1 then opens and interrupts AC power to the secondary or peripheral outlets.

The present invention serves to monitor components with the least amount of power loss or usage (such as the fuse, circuit breaker, or a length of wire), which is still within the detection range of the circuitry. Thus, the power consumption and heat load of the device is reduced without adding additional sensors or components.

The embodiments of device 10 described above are adapted to be plugged into a standard wall electrical outlet. It is contemplated, however, that other embodiments of the present device may be adapted to be wired directly into the existing electrical system of a residential or commercial structure (i.e. recess-mounted into, for example, a wall). In such an embodiment, device 10 would not include prongs on the rear thereof for mating with a standard electrical outlet. Rather, device 10 would include the necessary structure for wiring directly into an existing electrical system. It is contemplated that the various components, structures, and know-how for undertaking such a wiring are well known in the art. It is further contemplated that the present device may be used in association with a stand-alone device, such as, for example, a power strip, wherein the present device consumes less power hand produces less heat than existing devices due to the more efficient use of internal components in terms of how the present device senses a power increase or decrease to a primary device.

The present device may also include a light-emitting diode (LED) or other indicator for signaling to a user thereof that peripheral outlets 16 are receiving power.

It should be further noted that the present device, in a preferred embodiment, does not include a secondary power switch for the user to turn on the present device. This eliminates an inconvenience to the user of the present device, who need only mount the device on a wall and plug various electronic devices into it. The present device is, then, continuously ready to supply power to primary and peripheral devices without the user actively utilizing a switch to turn the present device on.

Thus, the device described above meets a need for energy conservation, and further meets a need for reducing the clutter of wires, cords, and the like, thereby reducing fire and other hazards. It is contemplated that the device may be further modified by, for example, adding a surge protection feature, an uninterruptable power-supply feature, phone or cable outlets, and the like. Methods of making such modifications will be readily ascertainable by those of skill in the art upon reading this disclosure.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. Such modifications are also intended to fall within the scope of the appended claims.

Having thus described the preferred embodiment of the invention, what is claimed as new and desired to be protected by Letters Patent includes the following:

1. A device for reducing energy waste comprising:
an electrical adapter having a plurality of outlets disposed along a surface thereof, said plurality of outlets including at least one primary outlet; and
a sensor for determining when power consumed by a device plugged into said at least one primary outlet drops below a predetermined threshold, the sensor detecting a change in current flowing through a component selected from the group consisting of a fuse, a circuit breaker, and a length of wire,
wherein said primary outlet controls at least one other of said plurality of outlets such that when power consumed by a device plugged into said primary outlet drops below said predetermined threshold, the power provided to said at least one other of said plurality of outlets is interrupted.

2. The device according to claim 1, wherein said device is sized and shaped to mate directly with a pre-existing electrical outlet.

3. The device according to claim 1, wherein the predetermined threshold is the threshold at which the device plugged into the primary outlet enters a mode selected from the group consisting of a sleep mode, a standby mode, and a power-saving mode.
